(19) United States
(12) Patent Application Publication
(10) Pub. No.: US 2007/0186702 A1
(43) Pub. Date: Aug. 16, 2007

(54) Method and device for the mechanical or magnetic transmission of force

(76) Inventor: Johannes Schroetter, Vaduz (LI)

Correspondence Address: NIXON & VANDERHYE, PC, 901 NORTH GLEBE ROAD, 11TH FLOOR, ARLINGTON, VA, 22203, US

(21) Appl. No.: 10/562,787

(22) PCT Filed: Jun. 30, 2004
(86) PCT No.: PCT/CH04/00410

§ 371 Date: Dec. 22, 2006

(30) Foreign Application Priority Data
Jun. 30, 2003 (CH) 1157/03
Sep. 12, 2003 (CH) 1556/03

(51) Int. Cl. F16D 27/10

(52) U.S. Cl. 74/125.5; 475/206

(57) ABSTRACT

The invention relates to a method and a device for transmitting force by means of spring interaction and/or magnetic interaction. According to the invention, a plurality of supports are provided for receiving or positioning one or several springs, shock absorbers, or similar, each support being disposed on bearing means. Each support is connected to one or several freewheeling means, e.g. freewheel bearings, such that each support is rotatably or movably guided in a single direction about an axis of rotation or along a straight or curved axis of translation. Furthermore, each support is fitted with one or several individual springs, shock absorbers, or similar in a predefined arrangement. A plurality of such supports are positioned at a distance from each other in such a way that a momentum transmitted to a first support is transmitted by said first support to an adjacent second support by means of spring interaction, is transmitted by said second support to the third support that adjoins the second support, etc. An essential characteristic of the invention lies in the fact that virtually the entire momentum is transmitted to the next closest respective support as a support that has been set in motion is prevented by the freewheeling means from travelling in the reverse direction such that an initial momentum that is transmitted once from an external source of momentum to the magnetic force-transmitting device can be transmitted practically free of loss across long distances similar to a wave. The momentum can be maintained for an extended period of time at low frictional resistance if the path of travel is closed, e.g. in a circle.

### FIELD OF THE INVENTION

The invention relates to a device for mechanical and/or magnetic transmission of force with the aid of movable springs, shock absorbers, magnets and the like that interact with one another.

### BACKGROUND OF THE INVENTION

Mechanical or magnetic force transmitting devices have long been known in which a driving force is transmitted from a first rotatably supported body to a second rotatably supported body. Such force transmissions are used in rigid clutches or so-called shaft compensation clutches. These can be obtained worldwide in many designs and on many principles.

### OBJECT OF THE INVENTION

The object of the present invention is to furnish an improved method and device for mechanical or magnetic force transmission, in particular pulse transmission, with which the torque transmitting capacity in particular can be improved. A further object is to furnish both a method and a device for mechanical force transmission with which pulses can be transmitted over long distances. It is also an object to propose a device with which some of the pulse energy can be caught.

### DESCRIPTION

According to the invention, the object is attained by a device in accordance with the preamble to claim 1, which is characterized in that the supports are each rotatably located on their own, independent axle. This device according to the invention has the advantage that transmission devices of arbitrary length can be constructed. Moreover, a device according to the invention can comprise identical units or elements.

Advantageously, for forming a pulse transmitting element, two supports each, spaced apart from one another, are disposed on a common axle in a manner fixed against relative rotation. Furthermore, a plurality of such pulse transmitting elements can be provided, which are disposed coaxially and spaced apart from one another along a common axis of rotation such that the springs, shock absorbers or magnets of one element can cooperate at least with those of an adjacent element. By the type of interaction, it is possible to transmit rotary pulses practically without loss. Expediently, the axle of the support or of the element, each rotatably disposed on a stationary frame, and the freewheel means (backstops) are solidly joined to the frame, so that the support or the element is rotatable in only one direction of rotation.

As already described above, one support can be embodied as a movable carriage, and a plurality of carriages can be disposed movably in only a certain direction in one row and spaced apart from one another on a rail, so that a starting pulse transmitted from an external pulse transducer to the first carriage is transmitted to the last carriage on the rail. Alternatively, as the support, a disk or ring may be provided, and a plurality of disks or rings may be located on one common axis of rotation or on a plurality of axes of rotation and spaced apart from one another in the form of a lineup of disks or rings. The geometries described are easy to achieve in practice and prove to be especially favorable.

Advantageously, a disk, ring, split ring or the like acting as a support is retained by a central or noncentral freewheel bearing, which assures that the support is supported and is rotatable in only one direction of rotation. The freewheel bearing may be a combination of a conventional bearing and a freewheel bearing. To keep the load on the freewheel bearing low, the rings, disks, carriages, etc. are expediently each located on suitable separate bearings, or are kept movable by them in at least one direction, and separate freewheel bearings are used that control the direction of travel or motion, for instance in combination with the gear wheel which cooperates with a corresponding toothing on the ring or on the disk. One skilled in the art can see that in the case where a plurality of bearings are used, they may be located on the inner and/or outer circumference of a ring.

It is conceivable to provide a circular disk as a support for the springs, shock absorbers, etc., and to locate a plurality of these disks in a common plane and spaced apart from one another rotatably in only a certain direction of rotation (with the axis of rotation perpendicular to the common plane), so that a starting rotary pulse transmitted from an external pulse transducer to the first disk is transmitted as far as the last disk in the arrangement of disks. The possibility exists of locating the disks such that all the disks rotate in the same direction of rotation or alternatingly in opposite directions of rotation, if the disks are located not one after the other but side by side. It is also conceivable to locate the disks in the form of a stack and in a circle.

In the case of a linear arrangement of supports cooperating with one another, it is conceivable to provide means for transmitting or feeding the pulse from the last support back to the first support again. Such means may for instance be an axle which connects the last support to the first support. As a bearing means for the supports, bearings of all kinds can be used, such as ball bearings, slide bearings, running bearings, or the like. The only significant aspect is that transporting or motion of the supports be assured with as little loss as possible, so that of the energy input externally in the form of a pulse, an excessive amount is not lost through friction.

In an especially preferred embodiment, for forming a single pulse transmitting element, two supports each, spaced apart from one another, are disposed on a common axle in a manner fixed against relative rotation. This has the advantage that the lengths of the force transmitting device can be made arbitrarily long. A plurality of such elements can be provided. They may be located along a common axis of rotation, coaxially and spaced apart from one another, in such a way that the spring means of one element are able to cooperate with at least one adjacent element.

Expediently, the supports are supported freely rotatably by means of a plurality of bearings located outside on the periphery, and on the inside of the ring a toothing is provided, with which a gear wheel retained by a freewheel bearing meshes. The common axis of rotation of the supports can be located on a straight line or on a curved path, preferably a circular path. Preferably, one or more first gear wheels, carrying the supports, are disposed on one or more axles in a manner fixed against relative rotation, and spaced from the axis of rotation of the aforementioned axles, at least one further second axle, with second gear wheels disposed on it with backstops, is provided, which second gear wheels can be brought into engagement with the first gear wheels directly, or by means of a chain or belt. By means of the second gear wheels, some of the pulse energy can be transmitted to an external pulse energy collector or caught.

Advantageously, means are provided for blocking or locking at least one element in a defined rotary position. These locking or blocking means can be formed by a locking bar, a gear wheel, a clutch or the like and can cooperate, preferably by positive engagement, with at least one element, preferably the second element, of a device. By means of the blocking means, the second pulse transmitting element of a corresponding device can for instance be locked, so that a first drive element can be subjected to the desired spring tension. Although in principle each support can be equipped with only one spring, in a preferred embodiment, each support is equipped with at least two springs spaced apart from one another.

Advantageously, additional inertial parts, such as flywheels, are disposed on the supports, pinions, gear wheels, backstops or axles, for increasing the pulse energy that is capable of being stored by the device. Thus the kinetic energy that can be stored in the device can be varied. In a preferred embodiment, a mechanism is provided for adjusting the maximum compression and/or relief of the spring. This makes it possible to maintain a residual tension between the springs of adjacent supports. For that purpose, the adjusting mechanism may be a frame disposed on the spring, or a threaded pin with a nut, for limiting the maximum compression and/or relief of the spring.

Expediently, the position and shape of the magnets on the individual supports is selected such that a residual tension which is always >0 is established between the magnets disposed on adjacent supports. In the case of springs or shock absorbers as well, their form or nature as well as their position on the individual supports are selected such that a residual tension between the springs or shock absorbers disposed on the adjacent supports is established which is always >0. Advantageously, the gear wheels, pinions or the like cooperating with one another are disposed such that the energy of motion from the individual elements can be carried to the outside, and the pinions or gear wheels can continue running with or without flywheels. To accomplish this, additional backstops can be provided on the inner, first gear wheels.

A preferred embodiment provides disposing one or more first gear wheels with backstops on one or more axles, and providing, spaced apart from the axis of rotation of the axles aforementioned axle, at least one second axle with second gear wheels, disposed thereon in a manner fixed against relative rotation, or second gear wheels with backstops, disposed thereon, which second gear wheels can be brought into engagement with the first gear wheels directly, or by means of a drive chain, belt, toothed belt, or the like. Furthermore, for attaining a variable dynamic pulse behavior, by a controller can be provided by providing that the energy of motion is carried to the outside from only every other element, or every third or every fourth element, and so forth. For instance, the energy can be carried to the outside from the second, fourth, sixth, and eighth element, etc., or from the third, sixth, ninth, and twelfth element, etc.

The invention is described in further detail below in conjunction with the drawings. In the drawings, the same reference numerals are used for the same elements.

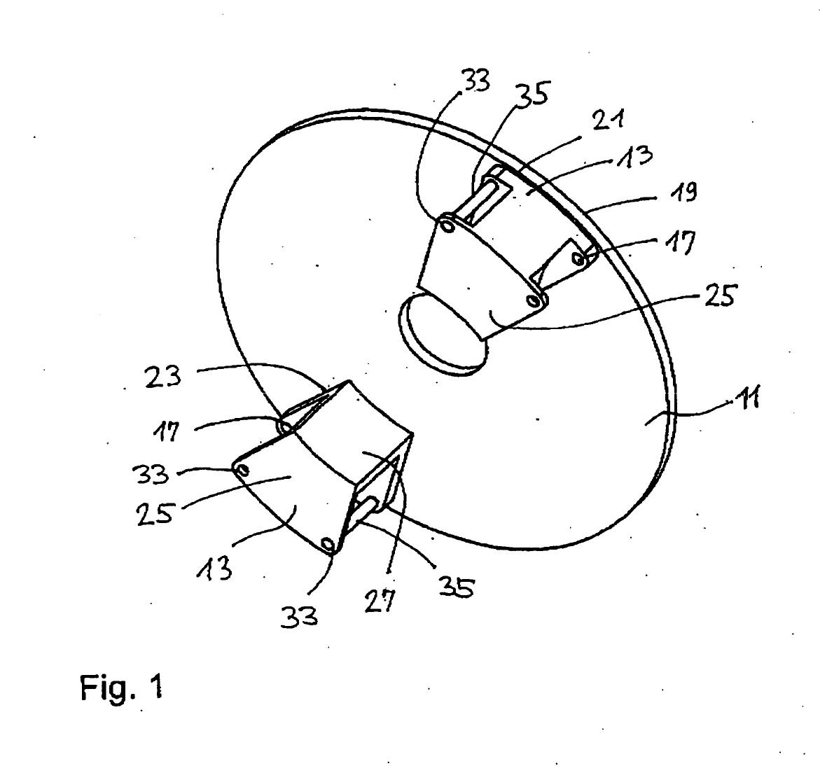

FIG. 1 is a perspective view of a disklike support with two mounts, facing one another, each for attaching one spring or shock absorber;

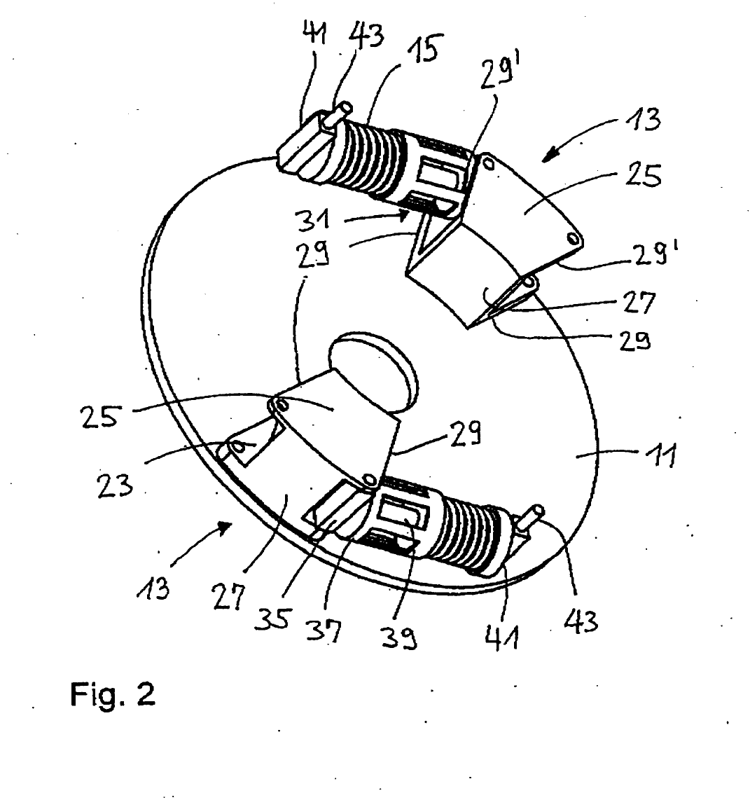

FIG. 2 shows the support of FIG. 1 with springs located on the bases;

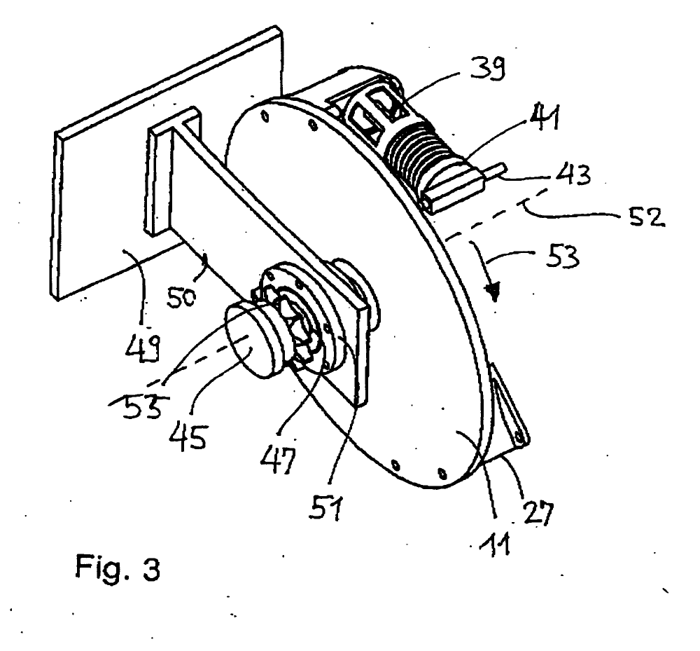

FIG. 3 shows the support of FIG. 2 located on an axle;

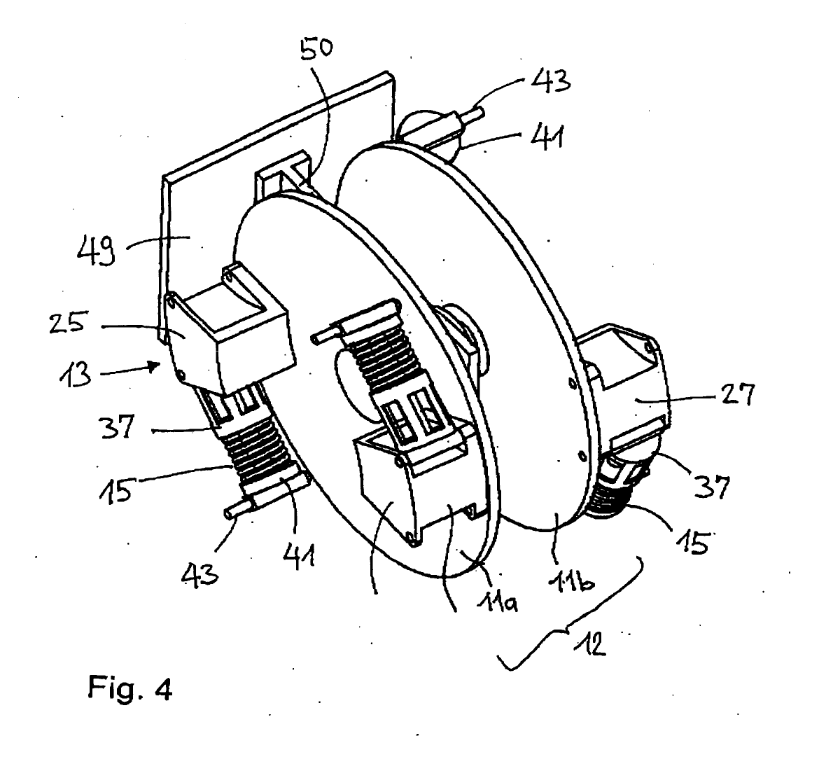

FIG. 4 is a perspective view of two supports (=a single pulse transmitting element) located rotatably on a common axle and spaced apart from one another;

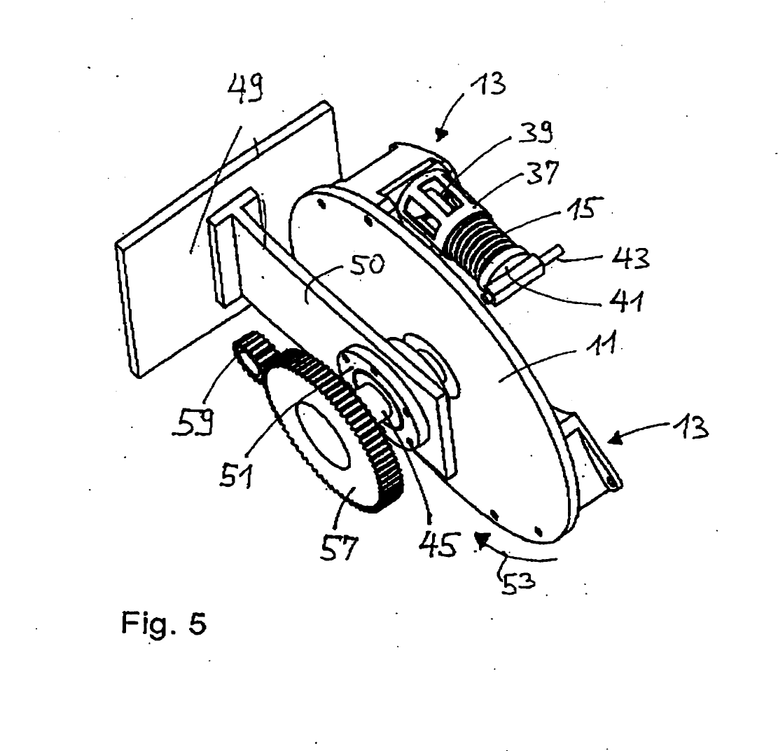

FIG. 5 shows a support, located rotatably on an axle, with a drive mechanism for driving or abutting the support (drive element);

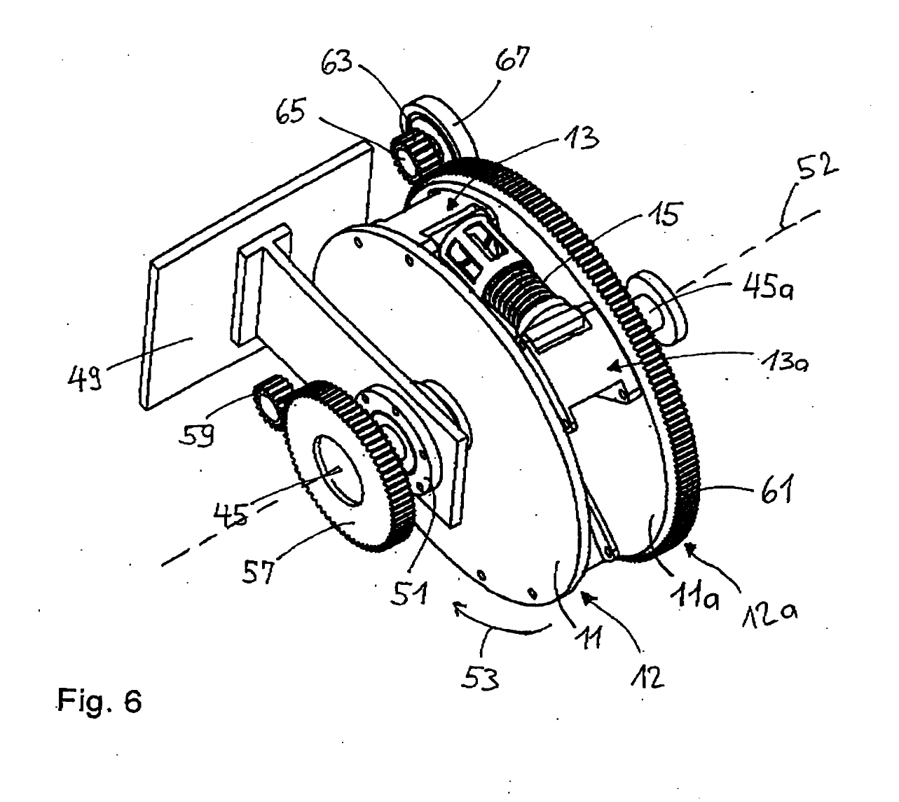

FIG. 6 shows the support of FIG. 5 with an additional mechanism for locking a rotating support in a defined rotary position;

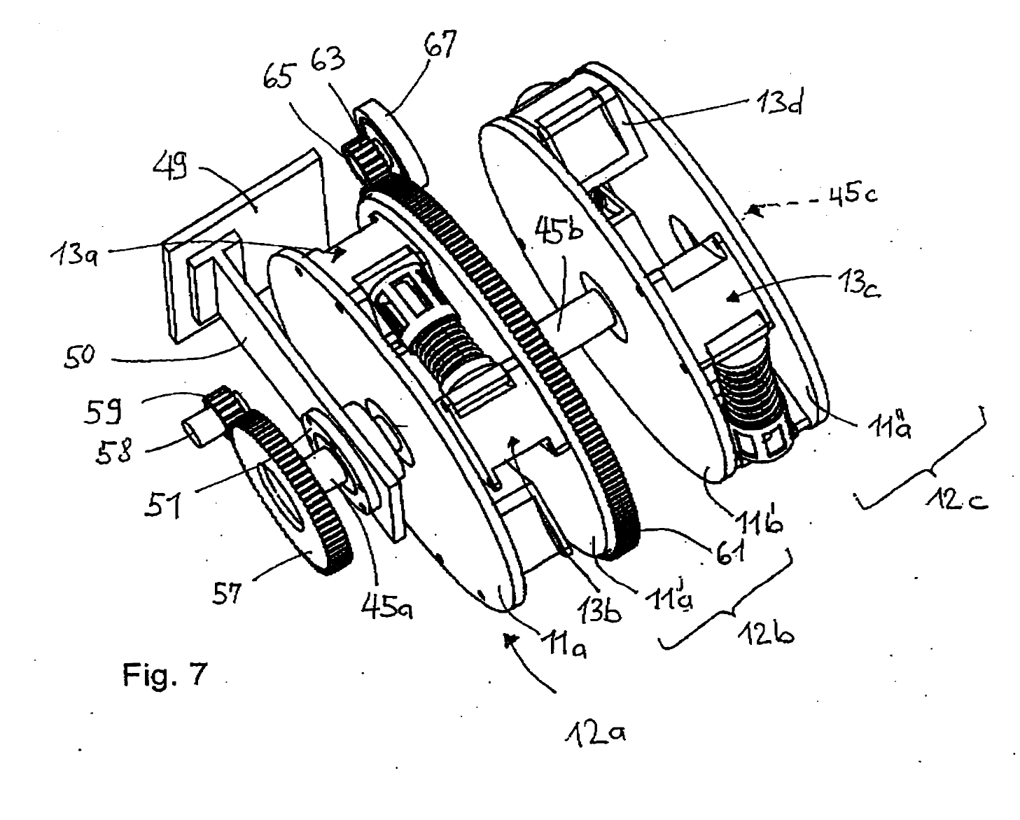

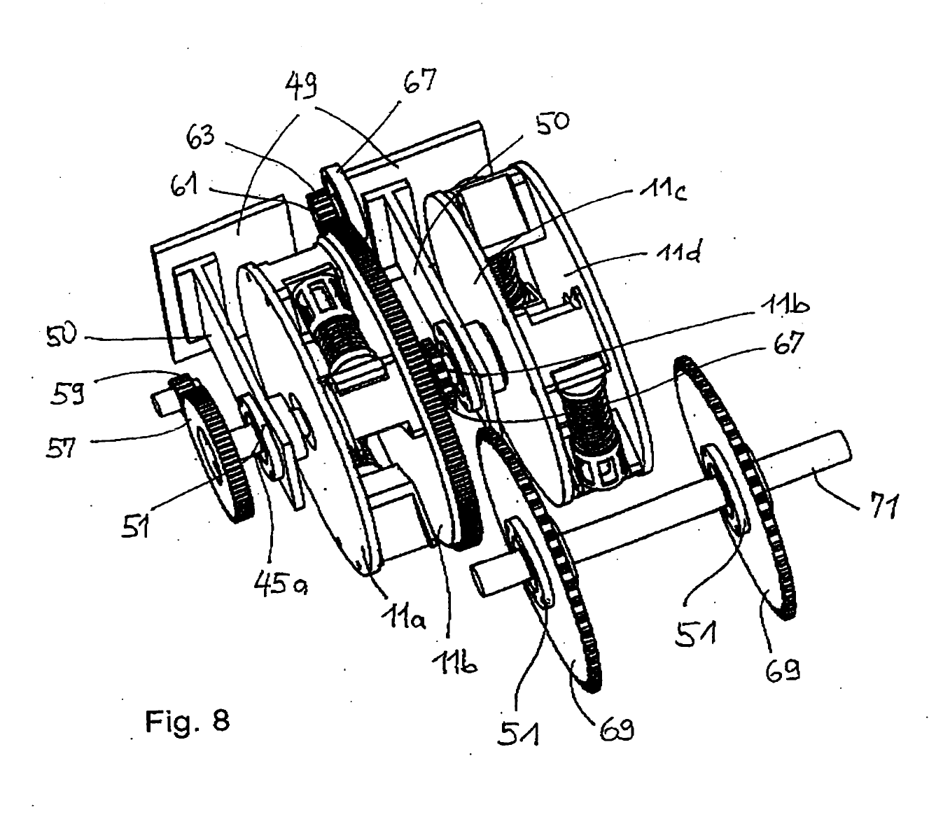

FIG. 7 is a fragmentary view of a device according to the invention with a drive element (see FIG. 3) and a pulse transmitting element;

FIG. 8 shows the device of FIG. 7 with an external shaft for catching pulse energy;

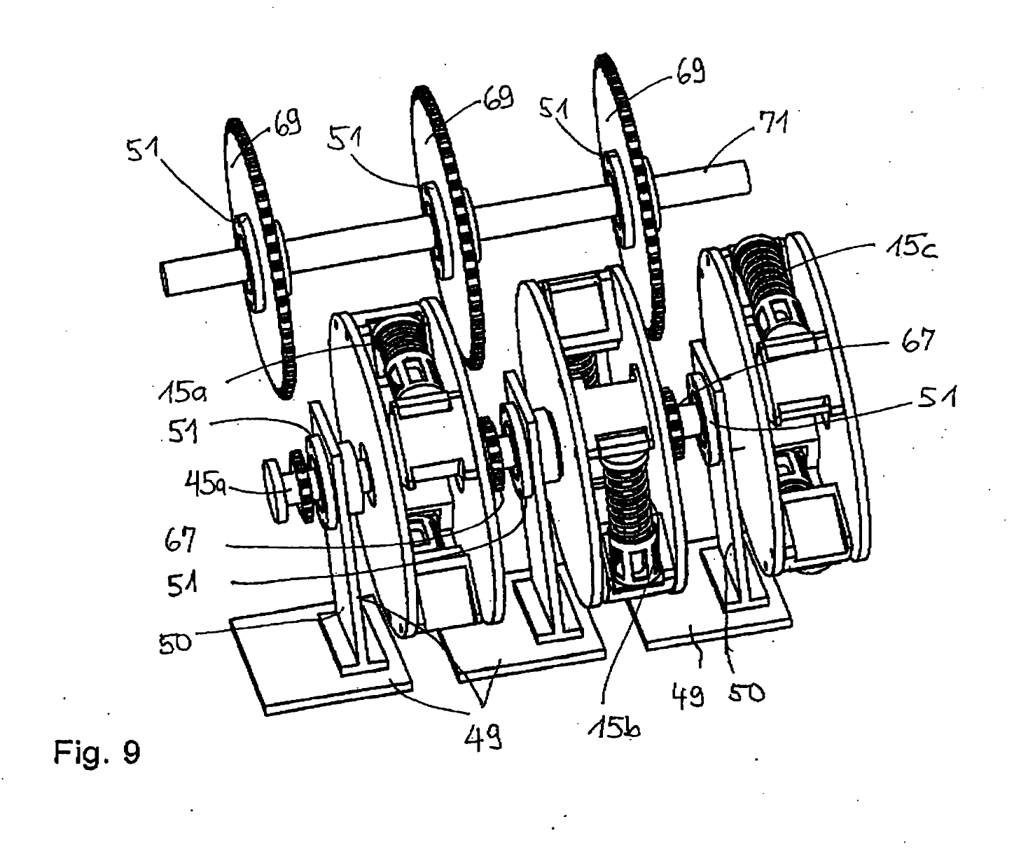

FIG. 9 is a perspective view of a further exemplary embodiment of a device according to the invention, having a plurality of supports spaced apart from one another along an axis of rotation;

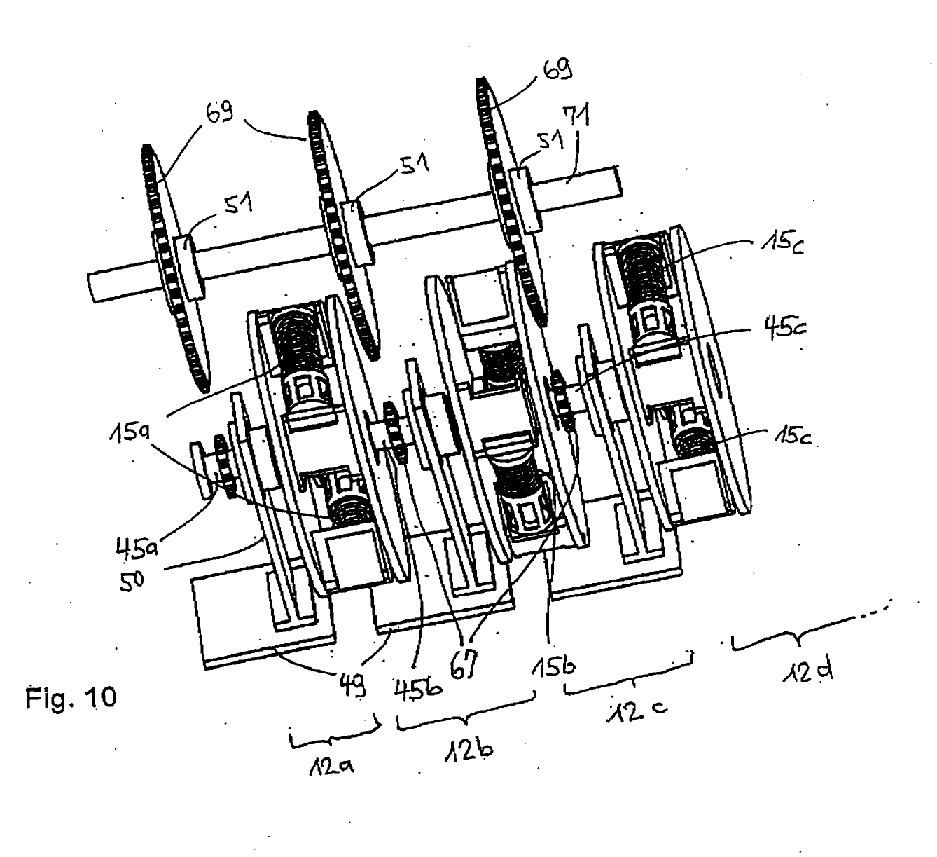

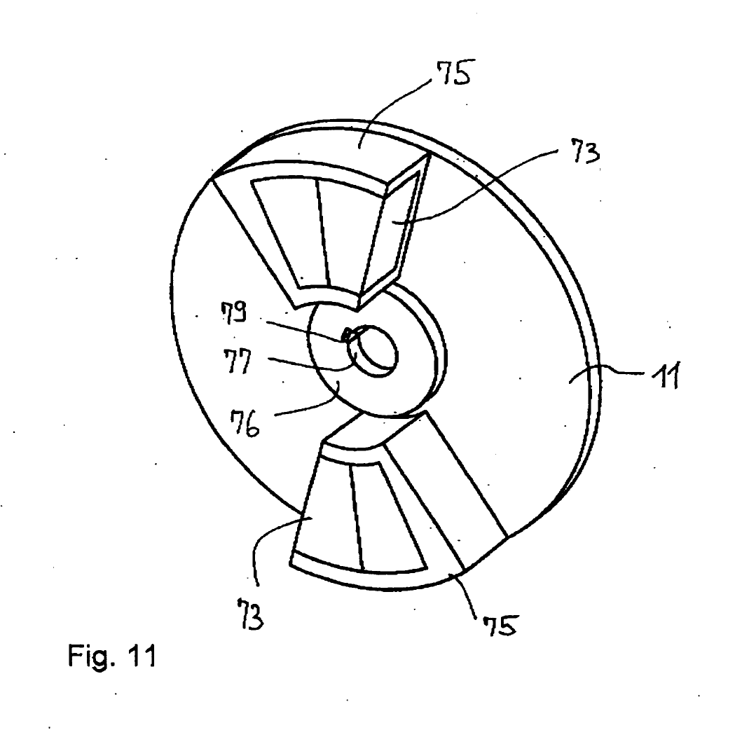

FIG. 10 shows the device of FIG. 9 in a second operating position of the supports;

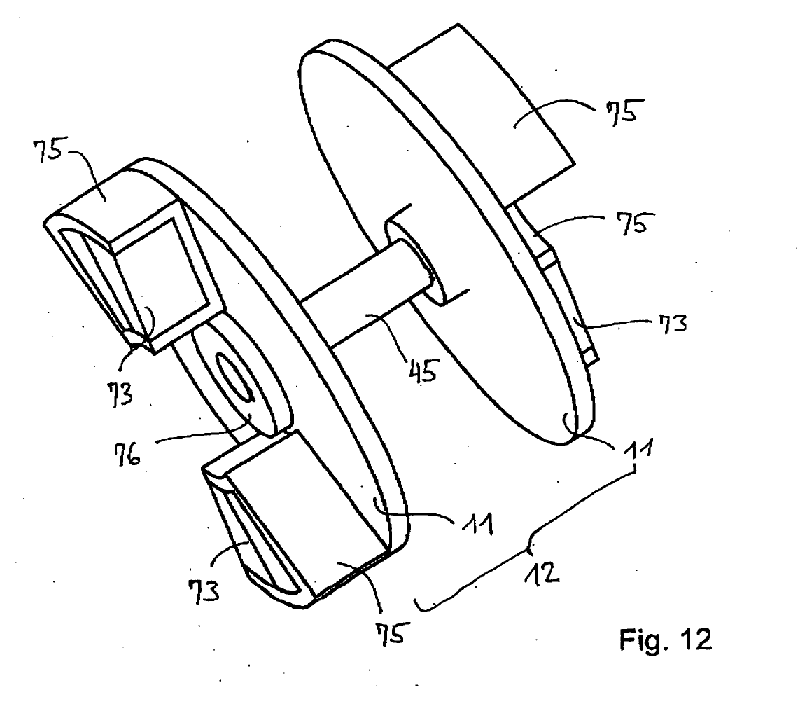

FIG. 11 shows a further embodiment of a support with two magnets located facing one another;

FIG. 12 shows a pulse transmitting element comprising two supports of the kind shown in FIG. 11;

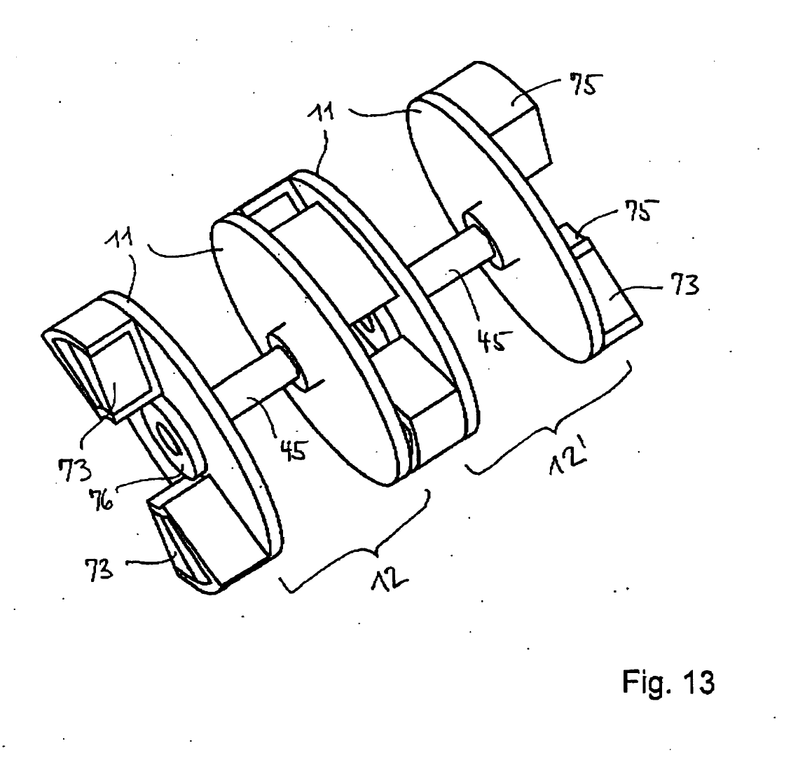

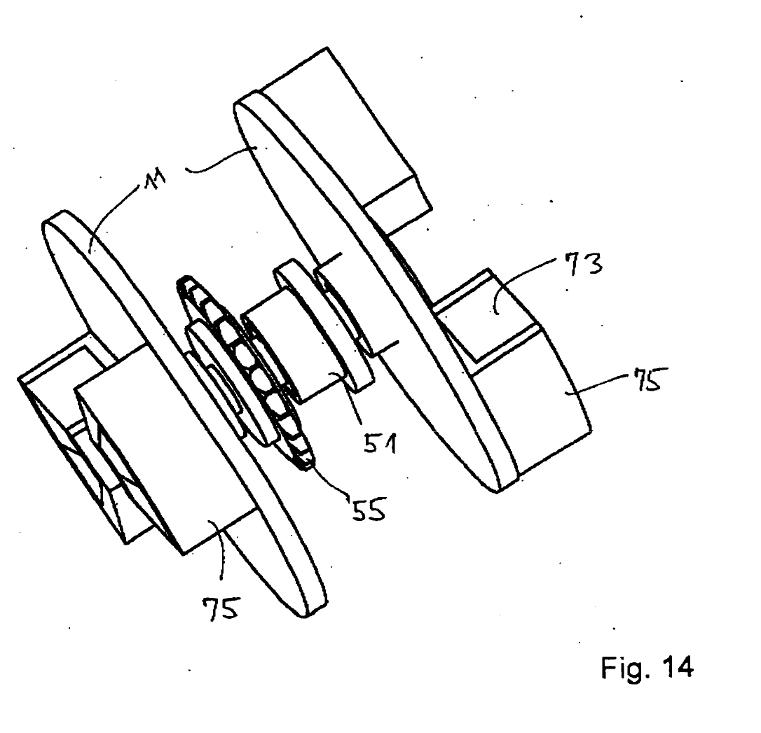

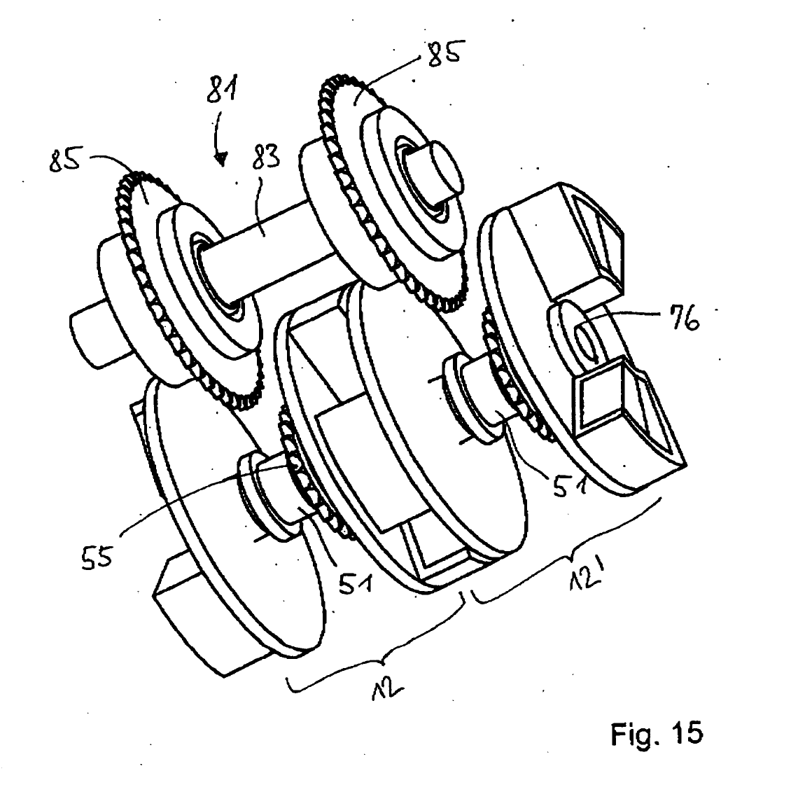

FIG. 13 shows a gear mechanism comprising two pulse transmitting elements of the kind shown in FIG. 12;

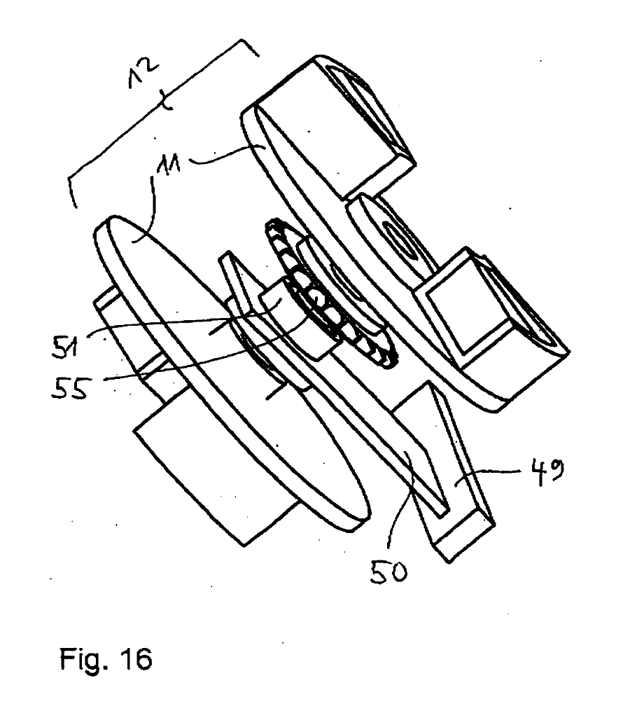

FIG. 14 shows the pulse transmitting element of FIG. 12 with a backstop and a gear wheel;

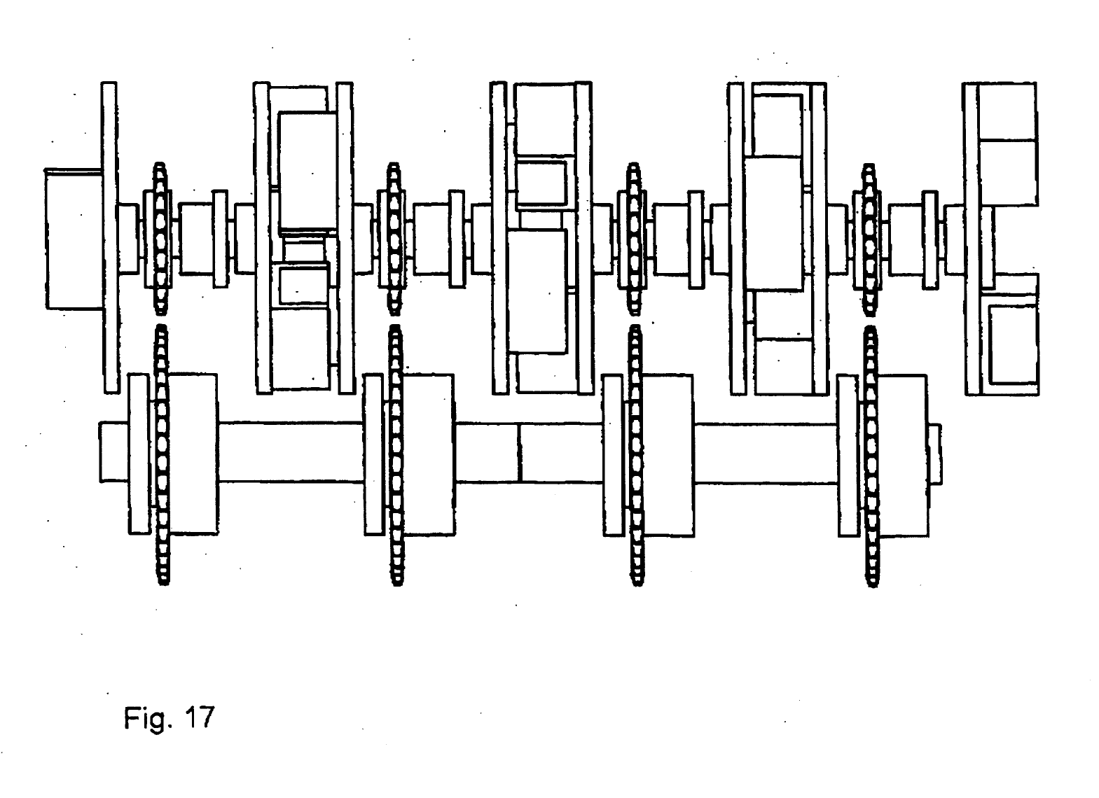

FIG. 15 shows a gear mechanism comprising two pulse transmitting elements as in FIG. 14 and an extraction gear mechanism located at a distance from the gear mechanism;

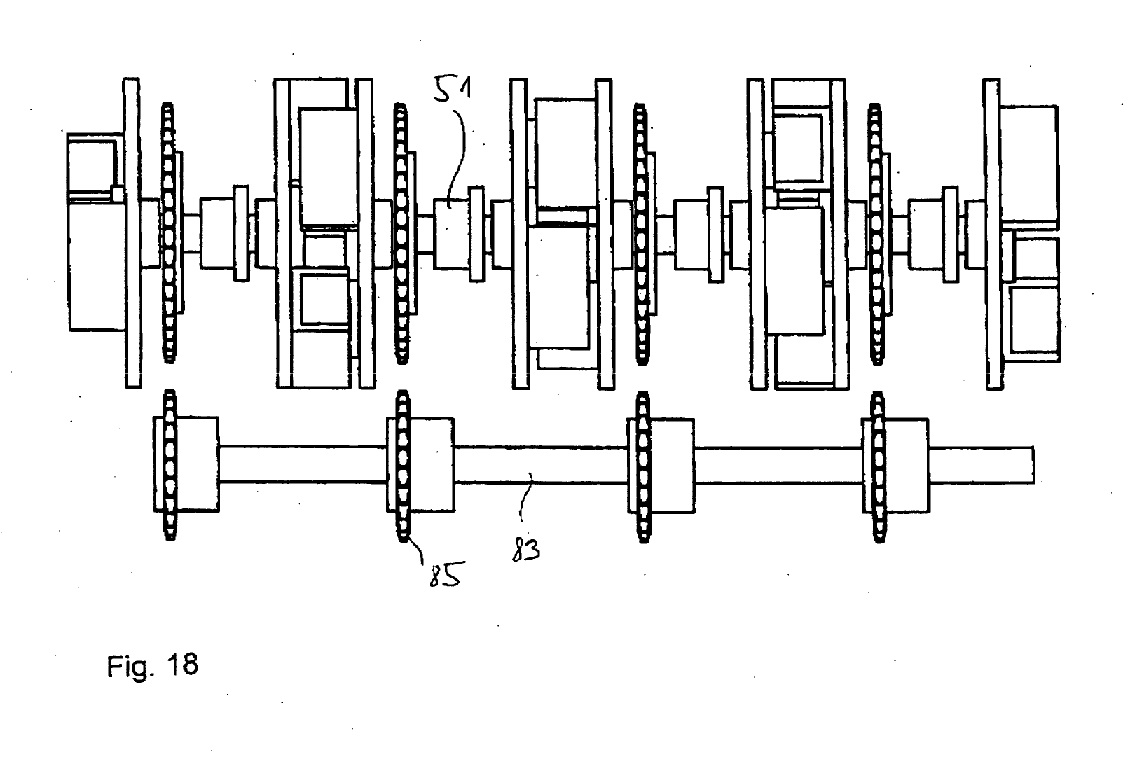

FIG. 16 shows the pulse transmitting element of FIG. 14 located on a frame;

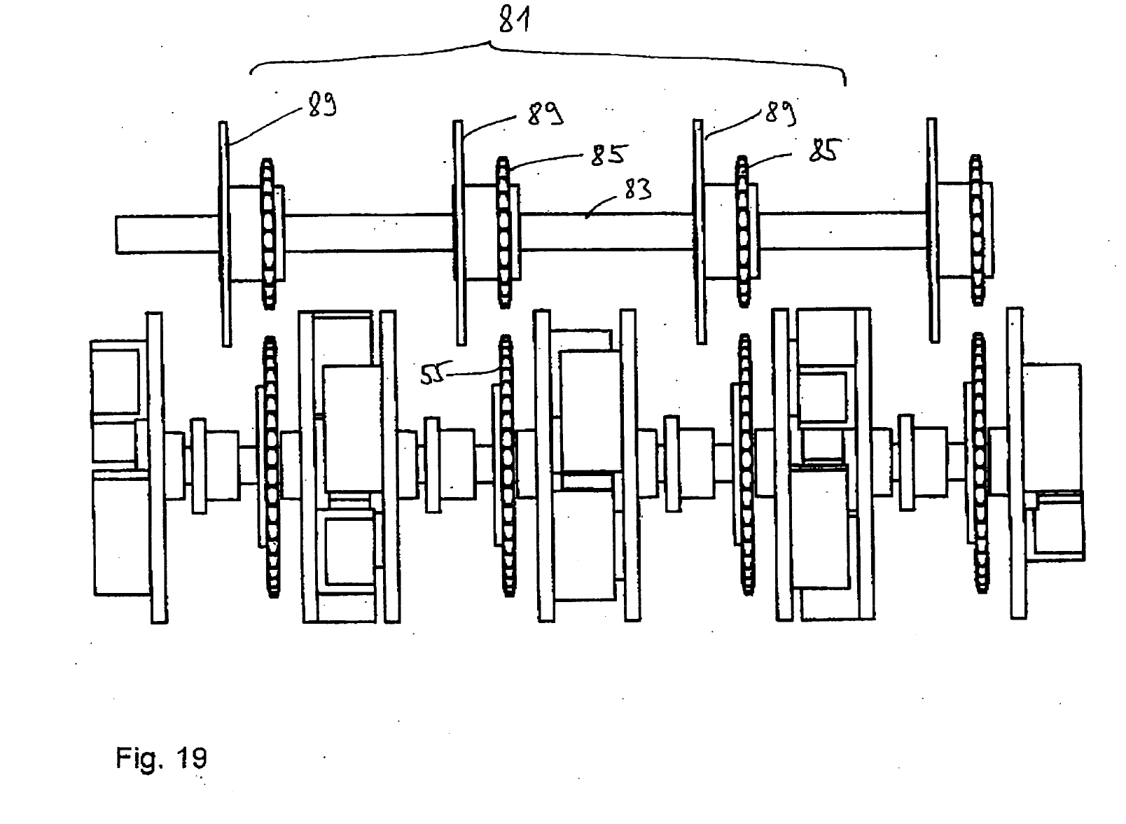

FIG. 17 shows a gear mechanism comprising a plurality of pulse transmitting elements, located in line with one another and in engagement with one another, and a decoupling gear mechanism;

FIG. 18 shows the gear mechanism of FIG. 17 with a different gear ratio;

FIG. 19 shows the device of FIG. 18 with flywheels additionally located on the decoupling gear mechanism;

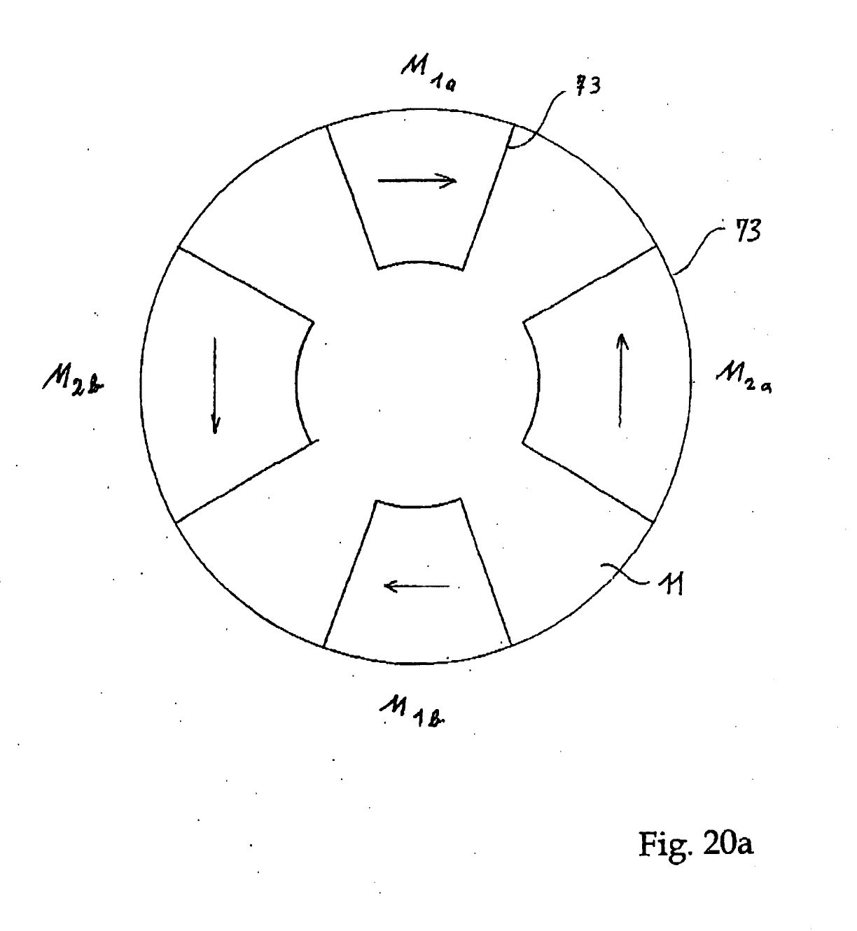

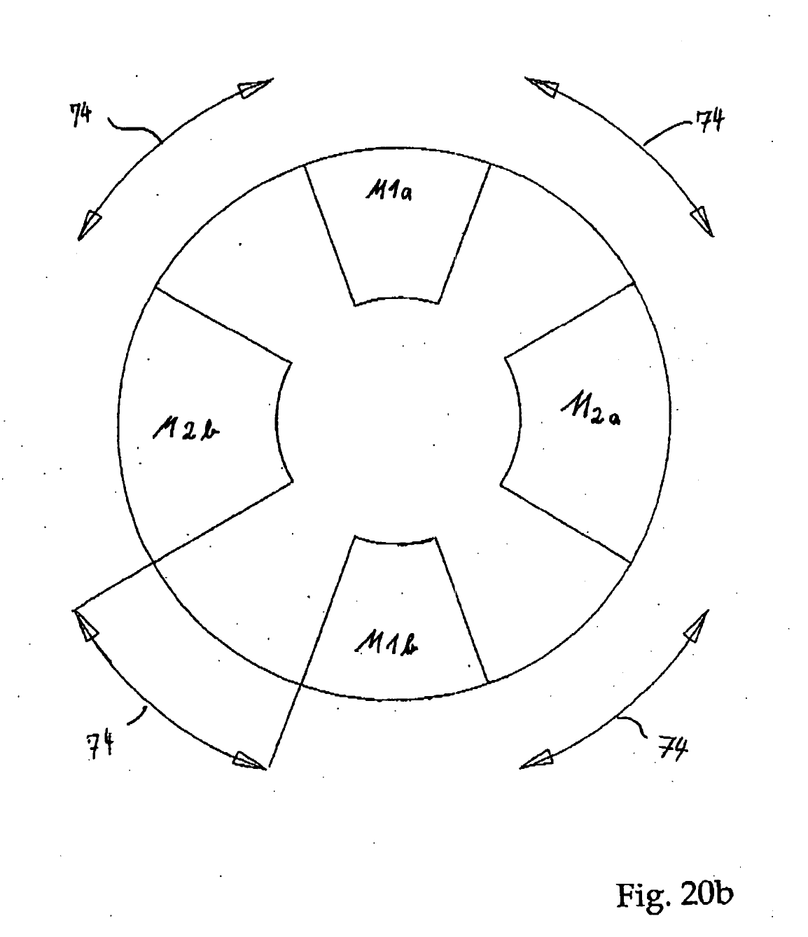

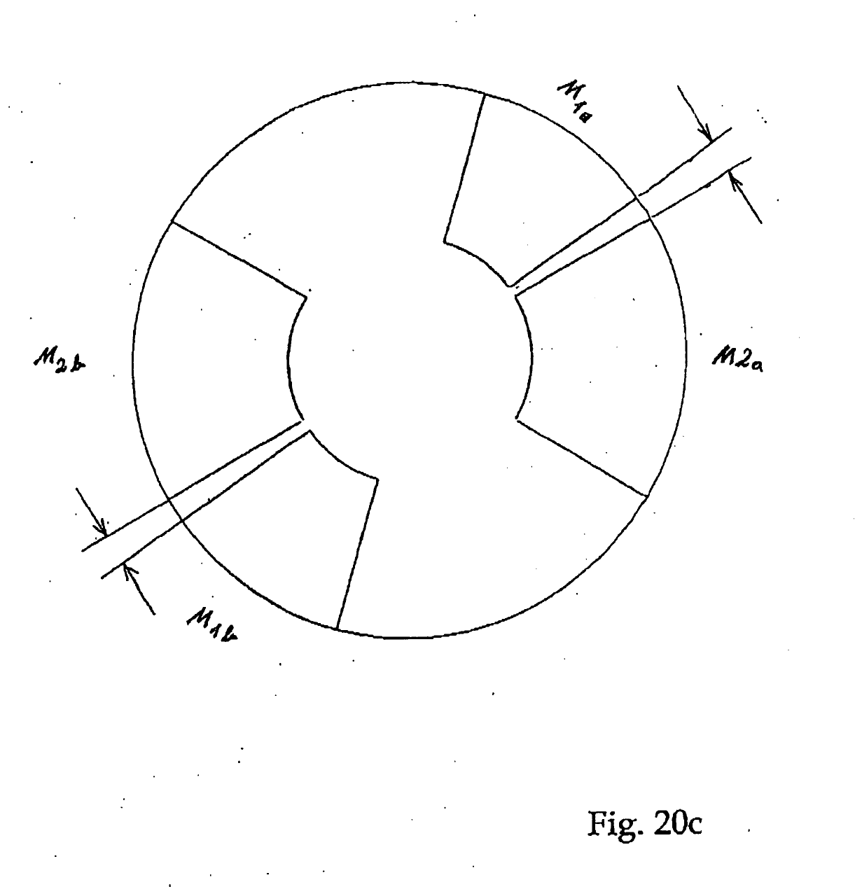

FIG. 20a) is a schematic illustration of the magnetization of the magnets of two adjacent elements;

FIG. 20b) shows the position of repose between the two elements of FIG. 20a);

FIG. 20c) shows the location of two magnets of two adjacent elements when tension has been built up (“compression”);

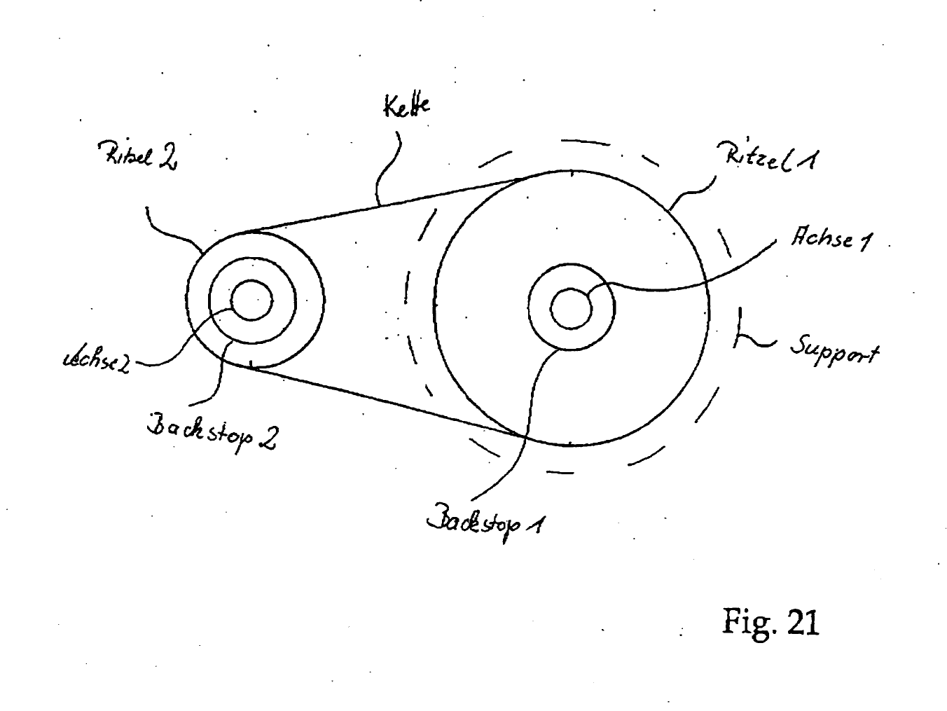

FIG. 21 shows a first embodiment of a basic arrangement for energy catching with pinions;

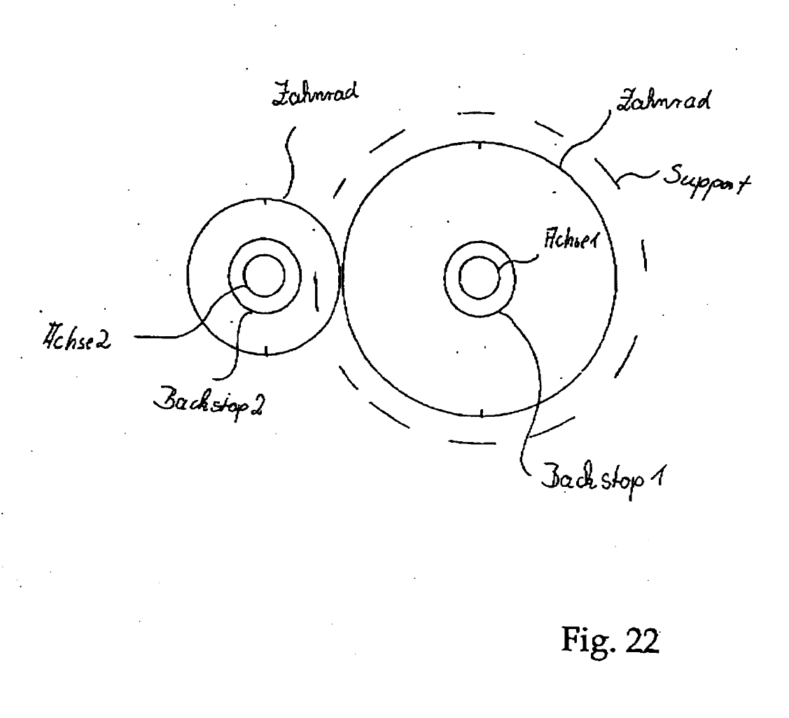

FIG. 22 shows a second embodiment of an arrangement for energy catching with gear wheels meshing with one another;

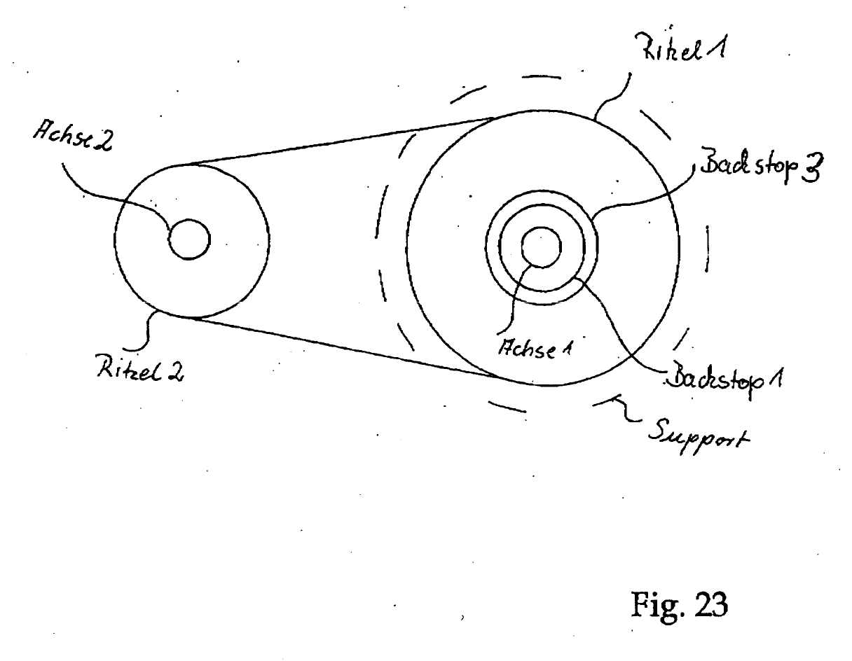

FIG. 23 shows a third embodiment of an arrangement for energy catching;

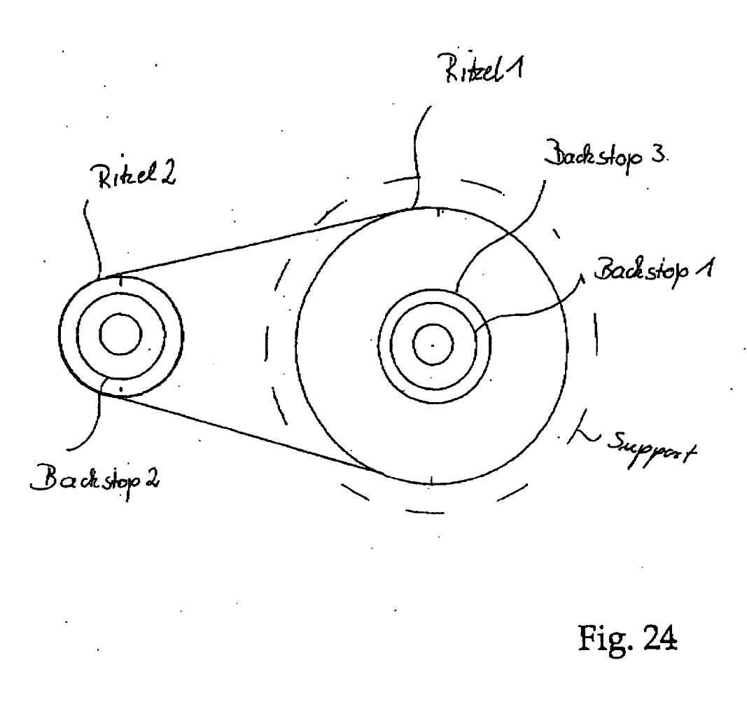

FIG. 24 shows a fourth embodiment of an arrangement for energy catching;

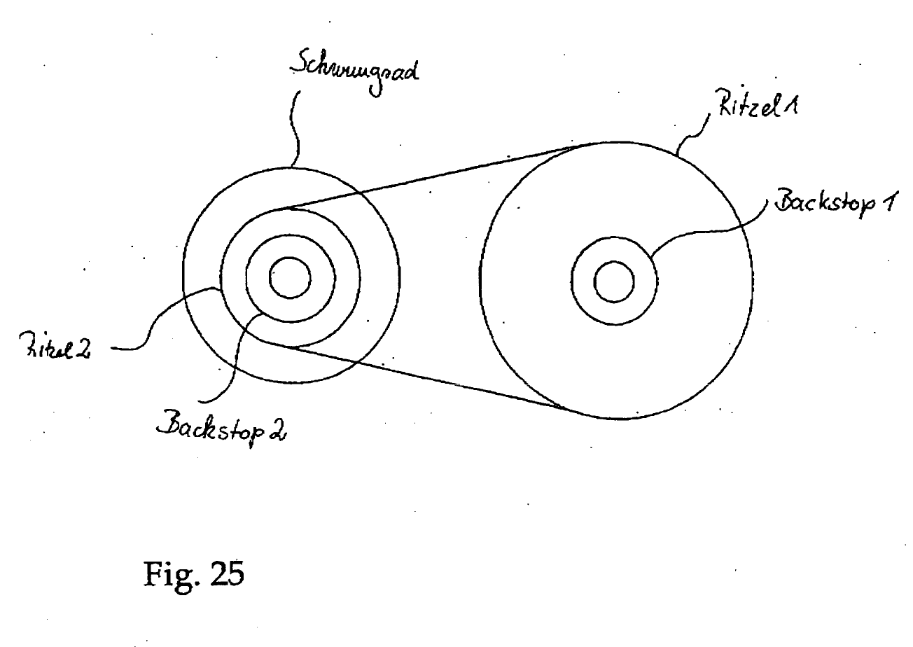

FIG. 25 shows a fifth embodiment of an arrangement for energy catching with a flywheel.

In FIGS. 1 through 3, a circular support 11 is shown, on which mounts 13, facing one another, for spring means 15 are provided (FIGS. 1 and 2). The mounts 13 comprise parts of approximately trapezoidal outline, which are fixedly located on the support 11 by means of screws or rivets 17. The mounts 13 are located at the edge 19 of the support 11 in such a way that the long base edge 21 of the trapezoidal mounts 13 is located on the outside, or may be flush with the support edge 19.

The trapezoidal mounts 13 have a base face 23, which rests on the support 11, and an end face 25, spaced apart from the base face 23. The base face 23 and end face 25 are fixedly joined together by a middle part 27. The middle part 27 together with the side edges 29, 29′ of the base face 23 and end face 25 forms a U-shaped seat, oriented toward the side, for the spring means 15. Round recesses 33 for receiving a pin 35 are provided in both the base face 23 and the end face 25.

In FIGS. 2 and 3, the spring means 15 are disposed on the mount 13. The spring means 15 include a spring 15, which is located on a foot part 37 and is located fixedly or detachably on the middle part 27 by means of a bolt or screw 39. The spring 15 is fastened between the foot part 37 and the screw head 41. A radially protruding pin 43 is provided on the screw head 41 and can act as a stop.

In FIG. 3, a support 11, equipped with springs 15, is fixedly located on an axle 45. The axle 45 is received in a bearing 47 not shown in further detail, which is located on a strut 50 of a frame 49. A “backstop” (reverse travel block) 51, located on the strut 50 and cooperating with the axle 45, assures that the axle 45 can rotate in only one direction of rotation 53 (which is the direction of pulse transmission). In principle, it is conceivable for the backstop 51 to be connected in a manner fixed against relative rotation to either the support 11 or the axle. For instance, it is conceivable for the axle 45 to be fixed against relative rotation and the backstop 51 to be fixedly connected to the support 11. The only aspect of significance for the function of the device is that the backstop 51 acts between the axle 45 and the support 11 and enables a rotation of the support 11 in only one direction of rotation 53. Via a pinion 55 connected to the axle 45 in a manner fixed against relative rotation, the energy from a given pulse can be carried to the outside.

In FIG. 4, a pulse transmitting element 12 comprising two supports 11a, 11b is shown. The supports 11a, 11b are spaced apart from one another and fixed against relative rotation on an axle 45, not shown in FIG. 4. Extending between the supports 11a, 11b is a strut 50, protruding at a right angle from the frame 49, with a round recess for the axle 45. At least one annular backstop 51 is fixedly located on the strut 50 and permits a rotation of the axle 45 in only one direction of rotation 53. The mounts 13 and spring means 15 are located on the outward-oriented sides of each of the disks 11a, 11b.

An element 12 as shown in FIG. 4 forms a single pulse transmission unit. A plurality of such elements 12 can be located, spaced apart from one another, on a common axis of rotation 52, so that a pulse transmitted to a first element 12 can be transmitted to an element 12a adjacent to the first element 12, from that element to the next element 12b, and so forth.

In a device comprising a plurality of elements 12 located on an axis of rotation 52, the elements 12 provided at the beginning and end of the device may, as shown in FIG. 3 or FIG. 5, have only one support 11. The elements provided between the end elements can then, as in FIG. 4, each be embodied with two supports 11a, 11b. Such a device makes it possible to transmit a pulse from a first element 12 to the last element in a row of elements.

The exemplary embodiment of FIG. 5 differs from that of FIG. 3 in that instead of the pinion 55, a gear wheel 59 is located on the axle 45. A driving gear wheel 59 cooperating with the gear wheel 57 makes it possible to put the support 11 in motion. In this exemplary embodiment as well, the backstop 51 assures that the axle 45 and the support 11, located on the axle 45 in a manner fixed against relative rotation, can rotate in only one direction 53.

FIG. 6 shows an exemplary embodiment in which the drive side of a device according to the invention is shown. The first element 12 of the drive side has only one support 11 with springs 15, which are capable of cooperating with an adjacent element 12a located on a second axle 45a. The elements 12, 12a are at such a spacing from one another that the springs 15, located on sides oriented toward one another of the elements 12, 12a, meet the mounts 13, 13a of the support 12a upon a relative rotation of the elements 12, 12a. If in operation a rotary pulse is transmitted to the element 12 via the driving gear wheel 59, the element 12 rotates in the direction of rotation 53 (arrow 53), and the springs 15 meet the mounts 13a of the element 12a. Because of the inertia of the mass, the springs 15 are initially compressed, until the element 12 begins to move. Since the first element 12 is prevented by the backstop 51 from moving in reverse, in the opposite direction from the direction of rotation 53, all the energy is transmitted from the element 12 to the element 12a. In FIG. 6, the device is shown at a moment in which the spring 15 shown is tensed.

In the exemplary embodiment of FIG. 6, a toothing 61 is provided on the circumference of the second element 12a; it meshes with the toothing 63 of a further gear wheel 65. The gear wheel 65 is connected to an electromagnetic or mechanical brake 67. The electromagnetic or mechanical brake 67 makes it possible to prevent the element 12a from rotating until the rotary pulse energy has all been converted into the spring energy. Thus if by means of the gear wheels 59 and 57 a spring tension is built up between 12 and 12a, this spring tension can instantly be released by release of the brake or clutch 67. Such a device should expediently be provided between the first and second elements 12,12a, or between the first and third, or first and fourth elements 12, 12a, and so forth, so that a strong starting pulse can be generated. In principle, a plurality of such brakes or clutches may be provided.

FIG. 7 shows an embodiment in which a plurality of elements 12a, 12b, etc. cooperate with one another. The element 12a is fixedly located on a first axle 45a, the element 12b is fixedly located on a second axle 45b, which is independent of the first axle, and the element 12c is fixedly located on a third, independent axle 45c (not shown in FIG. 7). For the sake of simplicity, certain parts, such as the backstop 51 and the frame 49 with the strut 50 for securing the shaft 45b, have been left out of the drawing (for them, see FIG. 8). If a pulse is transmitted to the axle 45a and thus the element 12a via the driving gear wheel 59, drivable by means of a drive shaft, and the gear wheel 57, then this pulse is transmitted by the springs 15a practically completely to the element 12b and from it to the element 12c (of the element 12c, only its support 11a″ is shown). In this way, a pulse, once transmitted to the device, migrates consecutively from one element to the next, until it has finally reached the end of the of a plurality of elements 12a, 12b, etc. in line with one another. In principle, it is conceivable for the pulse then to turn around and migrate back to the site where the pulse was first transmitted to the device. For that purpose, respective spring means 15a, 15b, etc. may be provided on the mounts 13a, 13b, etc. of adjacent elements 12a, 12b, etc. Such a device can in principle be used to store kinetic energy for a certain length of time.

FIG. 8 shows a mechanical pulse transmitting element with three elements 12a through 12c in line one after the other. The element 12b has a gear wheel 67, located in a manner fixed against relative rotation, on the axle 45b between the supports 11b and 11b′. The gear wheel 67 can cooperate with a gear wheel 69. The gear wheel 69 is located on a shaft 71, which extends parallel to the axis of rotation 52, with a backstop 51. By means of the gear wheels 69, energy from the pulse transmitting element can be transmitted to the shaft 71. To that end, the pinions 67 and 69 can be connected movably to one another with a chain, toothed belt, or the like, or directly, in the form of two gear wheels meshing with one another. When the support 11a rotates, the support 11b and thus the axle 45b are set into rotation as well. Via the pinions 67, 69, energy can be transmitted to the shaft 71. In principle, for the sake of catching energy, the backstops can be provided on either the pinion 69 or the pinion 67. The shaft 71 with the gear wheel 69 may be part of a pulse energy collector.

FIGS. 9 and 10 show a pulse transmitting element with four elements 12, in line with one another, in various operating positions. In FIG. 9, at a defined time t, the spring 15a is tensed and the springs 15b and 15c are untensed. At a subsequent time t+x, the pulse is transmitted from the element 12a to the elements 12b and 12c, and the springs 15b are tensed.

Preferably, spring means which make it possible to fix a residual tension setting should be selected. This can be attained by means of a mechanical device of the kind used in a shock absorber. The springs may also preferably be constructed such that upon complete relaxation, the engagement moment (shortly before the relaxation point) is still located relatively close to the maximum tension point. Preferably, a spring means of the kind in which the residual tension can be adjusted is employed.

The energy drawn should preferably be selected such that of the residual spring tension, for instance of 1000 kg, of the individual spring, it attains the torque of no more than 80% (800 kg). It is thus attained that the pulse is put relatively quickly and uniformly through the system (that is, the arrangement of a plurality of elements). If magnets are used, care must be taken that a residual magnetic tension (MRS) is preserved.

The centrifugal force of the individual elements or supports can also be mechanically increased, by selecting a large piston on the axle of the particular element and an equally small pinion outside in the “pulse energy collector”, but combines this with a large flywheel. The weight of the elements is thus mechanically moved upward. The flywheel and the backstop can for instance be embodied as a single unit. It is also conceivable for the inner pinion to be equipped with a backstop. Furthermore—as shown in FIG. 8—backstops may be provided on both the outer and the inner gear wheel 69 and 67, respectively.

FIGS. 11 and 12 show a further embodiment of a support 1 1 with two magnets 73 on one side of the support. The magnets 73 are solidly connected to the support 11 by means of a housing 75. In the center of the circular support 11, there is a flange 76 with a round hole 77 for receiving an axle 45. A groove 79 serves to receive a pin or splint, with which the support 11 can be disposed on an axle 45 in a manner fixed against relative rotation. The magnets 73 are oriented such that the magnetic field vector is oriented in the direction of repose, and no axial forces occur. The unit shown in FIG. 12 forms a so-called pulse transmitting element 12.

In FIG. 13, two pulse transmitting elements 12, 12′ are shown, located one behind the other and together forming a gear mechanism. The poles of the cooperating magnets 73 are oriented counter to one another, so that when the magnets approach each other, a force of repulsion is built up between the magnets. Consequently, the magnets pass the pulse onto an adjacent element 12 without touching one another.

FIG. 14 schematically shows a pulse transmitting element 12 with a backstop 51, located on the axle 45, and with a pinion 55.

FIG. 15 shows a gear mechanism comprising two elements 12, 12′ and an energy collector 81. The energy collector 81 has an axle 83, on which there are pinions 85 with a backstop. The spacing of the pinions 85 is equal to the spacing of the pinions 55. The pinions 55 and 85 can enter into engagement either by means of a chain, belt or the like, or directly, in the form of gear wheels and can thus drive the energy collector 81.

In FIG. 16, an element 12 is located on the strut 50 of the frame 49.

FIGS. 17 through 19 show gear mechanisms comprising a plurality of elements 12 with an energy collector 81 that is located parallel to the gear mechanism.

A small gear wheel, pinion on the element combined with a large gear wheel on the energy collector brings about an increase of torque at the energy collector axle (FIG. 17).

A large gear wheel, pinion on the element combined with a small gear wheel on the energy collector brings about an increase of speed at the energy collector axle (FIG. 18). Preferably, two gear wheels of medium size compared to the diameter of a support should be used, one on the element and one on the pulse collector. By the additional combination of the pinion/gear wheel with backstop on the “pulse energy collector” with a flywheel 89, the optimum energy yield can be attained (FIG. 19).

In conjunction with FIGS. 20a through 20c, the energy transmission will be described below as an example (M1b+M1a are the first element; M2b+M2a are the second element): In the position of repose, for instance between the magnets M1a+M2a, a residual tension (arrow 74) of 500 Nm prevails; that is, all the magnets are in the balanced position. The significant aspect is that the residual tension is >0 Nm. It is thus attained that upon the pulse transition, the torque is never below the respective residual tension. This applies equally to exemplary embodiments with magnets and exemplary embodiments with springs. The spacing (gap) between the magnets M1b and M2b, and M1a and M1b (arrows 78) corresponds to the tension built up characterizes.

For energy catching

FIG. 21 schematically shows a basic arrangement in which a pinion is located in a manner fixed against relative rotation on an axle 1 or support/disk. The backstop 1 permits the rotation of the axle 1 only in the pulse direction. The pinion 2 is fixedly connected to the backstop 2. The backstop makes it possible to transmit the applicable pulse, which is obtained from pinion 1 via pinion 2, to the axle 2. Once the pulse has been fully transmitted and the pinion 2 comes to a stop, then the pinion 2b with the backstop 2b and pinion 2c and backstop 2c, etc., located in line on the axle 2, can transmit the pulse, running through the arrangement, to the axle 2 without the other pinions, which are stopped, being carried along with it, since the applicable backstop 2 allows looping. The pinions can be connected to one another by a chain or belt. Instead of the pinions, however, gear wheels or the like may be used, as is shown in FIG. 22. In both examples (FIGS. 21 and 22), the energy of the total pulse can be picked up at the axle 2, and the axle 2 may also be subdivided (a plurality of individual generators for one long pulse chain). In principle, the axle may also be subdivided by means of clutches.

In the exemplary embodiment of FIG. 23, the pinion 1 is secured to the backstop 3, and the pinion 2 is located on the axle 2 in a manner fixed against relative rotation. In this exemplary embodiment, the backstop 3 performs the task of the backstop in the first exemplary embodiment.

The exemplary embodiment of FIG. 24 corresponds to a combination of the exemplary embodiments 1 and 3.

The fifth exemplary embodiment (FIG. 25) shows an arrangement with a flywheel. By the combination with a flywheel, an even more-perfect pulse transmission is attained. An increase in the centrifugal force is achieved as well. The use of flywheels has the further advantage that the desired intrinsic weight of the inner disks can be reduced (weight saving), if the flywheels are mounted on the outside of the pinions or backstops.

What is essential in the device of the invention is that a pulse or torque is transmitted by means of springs, shock absorbers, magnets, or the like from one support in a defined direction to a movably supported second support to the adjacent third support located movably in the same direction, and so forth. What is significant here is that each support is in communication with suitable means, for instance freewheel means such as freewheel bearings, so that the support can rotate or move forward in only one certain direction. Because the reverse travel of a support that is been put in motion is made impossible by the freewheel means used, a practically complete pulse transmission to the respective next support is accomplished, so that a starting pulse transmitted first from an external pulse transducer to the magnetic force transmitting device can be transmitted on the order of a wave practically without a loss over long distances. For the reader familiar with this subject matter, it is clear that within the scope of this invention, the most various arrangements and embodiments are conceivable and can be realized, without departing from the fundamental concept of the invention.

A perfect, self-compensating symmetry exists when each element of an arrangement adjusts automatically (that is, one after the other) to a new position once one or more elements of an arrangement is or are changed in its or their basic setting. It is advantageous if the direction of motion of all the elements in one and the same direction of rotation is limited. The number of elements does not matter, as long as

a) the internal tension in equilibrium of the individual elements to one another is higher than the total friction in the mechanical system;

b) at least one and preferably all the elements (on which forces act) are limited in one and the same direction of rotation.

1. The first primary principle of a dynamic, self-compensating mechanical and/or magnetic symmetry:

An asymmetrical, dynamic, self-compensating symmetry (of an arrangement of elements) that is not at rest is automatically restored symmetrically by means of its internal forces/torque-tensions of the individual elements, as long as the force/torque-tension acting on one another between each element interacting is greater than the sum of the friction in the total system; or more simply:

An asymmetrical, dynamic, self-compensating symmetry that is not at rest is restored from its own internal force, as long as the torque-tension acting in equilibrium with one another among the individual elements is greater than the sum of the friction in the total system.

2. The second primary principle of a dynamic, self-compensating mechanical and/or magnetic symmetry:

The amount of energy that is generated (that can be picked up at one or more collector axles) after one or more complete (in all elements) “restorations” (a pulsating element or pulsating elements cause asymmetrical→symmetrical reaction) can be greater (for a corresponding number of elements) than the initial energy (change in the position of one or more elements because of pulses) that causes an asymmetry, or more simply:

The amount of energy that is released in a symmetrical restoration of a dynamic, self-compensating mechanical and/or magnetic symmetry can be greater, when the number of elements is increased, than the amount of energy that causes or creates a pulselike symmetry in the system.

Gear wheels on the elements (see FIG. 14) put any asymmetrical step (driven pulse) outside the arrangement; gear wheel and backstop units (reference numeral 85 in FIG. 15) conduct the force (energy) onward individually, but in flowing fashion (overrun-clutch effect) to an axle, which is coupled to a generator. This “nonrepose” initiated (pulse at the first element) is pulsed during operation of the system constantly in sequences (repeated; to achieve synchronism, the second and third sequence is initiated immediately before the first and second pulse reaches the other end of the arrangement), time-shifted, but flowingly stored additional motion is converted into “energy”.

Numerical example, with 50 elements:

Energy Input at the 1st Element (Initiated Pulse, 60 Degrees)
↓
Energy Output at the 2nd through 50th Element
49 × 60 Degrees (Driven Pulse 2940 Degrees)
↓
Compensation of the Symmetry Causes “Energy Production”

Explanation:

The torque of the pulse, in our example, ranges between 1000 Nm (=maximum tension) and 500 Nm (=residual tension)=>750 Nm.

A skeptic will say that since friction is involved, this symmetrical arrangement will stop somewhere in the middle.

This is wrong, since 50 elements, for instance, in succession have a total distribution, including the collective, of 50 Nm of torque loss (500 Nm-50 Nm=450 Nm; 1000 Nm-50 Nm=950 Nm).

min 450 Nm, max 950 Nm

Average 700 Nm are continuously available, since the pulse is continuously repeated.

To obtain a rapid sequence of pulses, in practice 50% of the average torque (in this example, 350 Nm) is carried away to a generator.

### LIST OF REFERENCE NUMERALS

| | |
|---|---|
| 11 | Support |
| 13 | Mounts |
| 15 | Spring means |
| 17 | Screws or rivets Screws or rivets |
| 19 | Edge of the support (periphery) |
| 21 | Base edge of the trapezoidal mounts |
| 23 | Base face |
| 25 | End face |
| 27 | Middle part |
| 29, 29′ | Side edges |
| 31 | U-shaped seat |
| 33 | Recesses |
| 35 | Pin |
| 37 | Foot part |
| 39 | Bolt or screw for fastening the spring 15 |
| 41 | Screw head |
| 43 | Pin |
| 45 | Axle |
| 47 | Bearing |
| 49 | Frame |
| 50 | Strut of the frame with a recess for the axle |
| 51 | Backstop |
| 52 | Axis of rotation of the axle 45 |
| 53 | Direction of rotation |
| 55 | Pinion |
| 57 | Gear wheel |
| 59 | Driving gear wheel |
| 61 | Toothing on the circumference of the support |
| 63 | Toothing of the electromagnetic or mechanical brake |
| 65 | Gear wheel of the electromagnetic or mechanical brake |
| 67 | Gear wheel between the supports |
| 69 | Gear wheel on the axle 71 |
| 71 | Axle of the pulse energy collectors |
| 73 | Magnets |
| 74 | Arrow for residual tension |
| 75 | Housing |
| 76 | Flange |
| 77 | Round hole |
| 79 | Groove |
| 81 | Energy collector |
| 83 | Axle |
| 85 | Pinion |
| 89 | Flywheel |

1. A device for force transmission by means of mechanical interaction, having
a plurality of supports (11) for receiving or disposing one or more springs, shock absorbers, or magnets;
at least one axle, on which the supports are rotatably disposed by means of bearing means;
one or more freewheel means (19), in particular freewheel bearings, which act between the individual supports (11) and the at least one axle, so that the supports (11) that carry the spring, shock absorber or magnets (15) are rotatable in only one direction of motion (20) either about an axis of rotation (15);
springs, shock absorbers or magnets disposed on the supports, which are each oriented in the direction of motion of the support; and
an arrangement of adjacent supports such that the springs, shock absorbers or magnets disposed on the supports can cooperate with one another for the sake of transmitting pulses to one another,
characterized in that
the supports are each rotatably disposed on their own independent axle.

2. The device as recited in claim 1, characterized in that for forming a pulse transmitting element, two supports (11) each, spaced apart from one another, are disposed on a common axle in a manner fixed against relative rotation.

3. The device as recited in claim 1 or 2, characterized in that a plurality of such pulse transmitting elements are provided, which are disposed coaxially and spaced apart from one another along a common axis of rotation such that the springs, shock absorbers or magnets of one element can cooperate at least with those of an adjacent element.

4. The device as recited in one of claims 1 through 3, characterized in that the axle of the support (11) or of the element (12), each rotatably disposed on a stationary frame (49, 50), and the freewheel means (19) are solidly joined to the frame (49, 50), so that the support (11) or the element (12) is rotatable in only one direction of rotation.

5. The device as recited in one of claims 1 through 4, characterized in that as the support (11), at least one ring or disk is provided, and a plurality of such supports (11a, 11b, 11c, etc.) is disposed on a common axis of rotation (15) and spaced apart from one another in the form of a stack or a row with one another, so that a starting pulse, transmitted from an external pulse transducer to the first support (111) of the stack is transmitted to the last support (11ₙ) of the stack.

6. The device as recited in one of claims 1 through 5, characterized in that the supports (11) are freely rotatably supported by means of a plurality of bearings (17) resting
outside on the periphery; and that on the inside of the ring a toothing (27) is provided, with which a gear wheel (23), held by a freewheel bearing (19), meshes.

7. The device as recited in one of claims 1 through 6, characterized in that the common axis of rotation of the supports corresponds to a straight line (15) or a curved path, preferably a circular path (49).

8. The device as recited in one of claims 1 through 7, characterized in that as the support (11) for the spring means (15), a circular disk, ring, split ring, or the like is provided, and a plurality of such disks is disposed rotatably in only one direction of rotation (53) in a common plane, spaced apart from one another by means of one or more corresponding bearings, so that a starting rotation pulse transmitted from an external pulse transducer to the first disk is transmitted onward as far as the last disk in the disk arrangement.

9. The device as recited in one of claims 1 through 8, characterized in that one or more first gear wheels (67) are disposed on one or more axles (45) in a manner fixed against relative rotation; that spaced from the axis of rotation (52) of the axles (45), at least one second axle (71), with second gear wheels (69) disposed on it with backstops (51), is provided, which second gear wheels (69) can be brought into engagement with the first gear wheels (67) directly, or by means of a drive chain, belt, toothed belt, or the like.

10. The device as recited in one of claims 1 through 9, characterized in that means are provided for blocking or locking at least one element in a defined rotary position.

11. The device as recited in one of claims 1 through 18, characterized in that the locking or blocking means are formed by a locking bar, gear wheel, clutch or the like and can cooperate, preferably by positive engagement, with at least one element, preferably the second or third or fourth element, and so forth, of a device.

12. The device as recited in claim 11, characterized in that each support (11) is equipped with at least one spring (15), and preferably with two springs (15) spaced apart from one another.

13. The device as recited in one of claims 1 through 12, characterized in that the bearing means are ball bearings, freewheel bearings, slide bearings, air bearings, or combinations of freewheel bearings and ball bearings.

14. The device as recited in one of claims 1 through 13, characterized in that additional inertial parts, such as flywheels, are disposed on the supports, pinions, gear wheels, backstops or axles, for increasing the pulse energy that is capable of being stored by the device.

15. The device as recited in one of claims 1 through 14, characterized in that a mechanism is provided for adjusting the maximum compression and/or relief of the spring.

16. The device as recited in claim 15, characterized in that the adjusting mechanism is a frame disposed on the spring, or a threaded pin with a nut, for limiting the maximum compression and/or relief of the spring.

17. The device as recited in one of claims 1 through 16, characterized in that the position and shape of the magnets on the individual supports is selected such that a residual tension which is always >0 is established between the magnets disposed on adjacent supports.

18. The device as recited in one of claims 1 through 16, characterized in that the position and shape or nature of the springs or shock absorbers on the individual supports is selected such that a residual tension which is always >0 is established between the springs or shock absorbers disposed on the adjacent supports.

19. The device as recited in one of claims 1 through 18, characterized in that the gear wheels, pinions or the like cooperating with one another are disposed such that the energy of motion from the individual elements can be carried to the outside, and the pinions or gear wheels can continue running with or without flywheels.

20. The device as recited in claim 19, characterized in that additional backstops are provided on the inner, first gear wheels.

21. The device as recited in one of claims 1 through 20, characterized in that one or more first gear wheels (67) with backstops are disposed on one or more axles (45); that spaced apart from the axis of rotation (52) of the axles (45), at least one second axle (71) with second gear wheels (69), disposed thereon in a manner fixed against relative rotation, or second gear wheels (69) with backstops (51), disposed thereon, is provided, which second gear wheels (69) can be made to mesh with the first gear wheels (67) directly, or by means of a drive chain, belt, toothed belt, or the like.

22. The device as recited in one of claims 1 through 21, characterized in that a controller is provided, for attaining a variable dynamic pulse behavior, by providing that the energy of motion is carried to the outside from only every other or every third or every fourth element, and so forth.
